(19) United States
(12) Patent Application Publication
(10) Pub. No.: US 2003/0117244 A1
(43) Pub. Date: Jun. 26, 2003

(54) Dielectric resonance element, dielectric resonator, filter, resonator device, and communication device

(76) Inventors: Fumio Matsuura, Omihachiman-shi (JP); Toru Kurisu, Omihachiman-shi (JP); Hirotsugu Abe, Omihachiman-shi (JP); Masamichi Ando, Kyoto-shi (JP)

Correspondence Address: DICKSTEIN SHAPIRO MORIN & OSHINSKY LLP, Richard LaCava, 41st Floor, 1177 Avenue of the Americas, New York, NY, 10036-2714, US

(21) Appl. No.: 10/317,107

(22) Filed: Dec. 12, 2002

(30) Foreign Application Priority Data
Dec. 13, 2001 (JP) 2001-380592
Oct. 7, 2002 (JP) 2002-294167
Oct. 30, 2002 (JP) 2002-316210

(51) Int. Cl. H01P 7/10

(52) U.S. Cl. 333/219; 333/202

(57) ABSTRACT

A dielectric resonance element comprises a dielectric member integrally formed and composed of first and second plate portions which intersect each other such that respective center lines of the plate portions are coincident with each other. The first and second plate portions cause TE01δ resonance modes to develop, in which the electric field vectors of the TE01δ resonance modes are turned in the in-plane directions of the plate portions.

### BACKGROUND OF THE INVENTION

1. Field of the Invention

The present invention relates to a TE01δ mode dielectric resonance element, a dielectric resonator containing the same, a filter, an oscillator device, and a communication device provided with them.

2. Description of the Related Art

For dielectric filters, reduction of losses and enhancement of frequency-selection properties are required in order to effectively utilize frequencies. To attain these properties, dielectric resonators having a high non-load Q (hereinafter, simply referred to Qu) characteristic are used.

Moreover, for resonators provided with dielectric resonators, dielectric resonators having a high Qu characteristic are used to achieve the reduction of a noise and the stabilization of temperature characteristics.

Dielectric resonators utilizing a TE01δ mode are available as the above-described dielectric resonators having a high Qu characteristic. The TE01δ single mode resonators have very simple shapes such as cylinders, columns, polygonal columns, and so forth. Thus, the design and production can be easily carried out. However, when a multi-stage filter is formed, resonators are arranged in one row in a cavity. This causes a problem in that the whole size is increased.

As dielectric resonators having a multiplex TE01δ mode, (1) Japanese Unexamined Patent Application Publication No. 2001-160702 proposes “Triple Mode Spherical Dielectric Filter and Production of the same”, and (2) Japanese Unexamined Patent Application Publication No. 5-63414 proposes a “Dielectric Resonator Device”. It should be noted that the TE101 mode expressed in the rectangular coordinate is the same resonance mode as the TE01δ expressed in the cylindrical coordinate.

A filter or the like which is small in size and has a high Qu can be formed by use of the above-described multiple TE01δ mode.

However, very high-degree techniques are required to produce the spherical or substantially spherical resonator, using a ceramic sintering, as described in (1) Japanese Unexamined Patent Application Publication No. 2001-160702 and (2) Japanese Unexamined Patent Application Publication No. 5-63414. Generally, the processing is difficult to carry out, and the cost is very high.

When a filter having at least four stages is formed by use of triple mode resonators having the above-described configuration, so-called multi-coupling readily occurs. Moreover, the adjustment which is carried out to avoid the multi-coupling is very difficult. Thus, special countermeasures are required. It should be noted that in (1) Japanese Unexamined Patent Application Publication No. 2001-160702 proposing “Triple Mode Spherical Dielectric Filter and Production of the Same”, specific means for forming a filter having at least four stages is not disclosed.

As described in (2) Japanese Unexamined Patent Application Publication No. 5-63414 proposing a “Dielectric Resonator Device”, it is relatively easy to form a filter with at least four stages by coupling resonators to each other using a coupling loop. However, in this case, problems are caused in that the Q factors of the resonators are remarkably reduced due to the coupling loop, and the inherent high Q characteristics can not sufficiently utilized.

Moreover, Japanese Unexamined Patent Application Publication No. 9-162646 discloses an oscillator using a dielectric resonator in which signals from a BS satellite broadcast and a signal from CS broadcast are received by one converter. When two signals with different frequency bands are received as described above, two local oscillators corresponding to the respective frequency bands are required. According to the related art, resonators having TE01δ single modes corresponding to the respective frequencies are used. That is, two TE01δ single mode resonators are used.

The number of the used dielectric resonators can be reduced by applying the triple mode dielectric resonator described in Japanese Unexamined Patent Application Publication No. 201-160702 or NO. 5-63414 to the resonator parts of the above-described oscillator device. However, a third resonance mode which is not used in the oscillator exists, so that an undesired coupling mode is generated near the desired resonance frequency. That is, this device is not practically useful.

### SUMMARY OF THE INVENTION

It is an object of the present invention to provide a dielectric resonance element having a dual TE01δ mode and to provide a device using the same.

It is another object of the present invention to provide a dielectric resonance element which causes no problems of multi-coupling, even when a filter comprising at least a four stage resonator is formed, and to provide a device using the same.

It is another object of the present invention to provide a dielectric resonance element which can be used in a two frequency wave oscillation device in which no inconveniences are caused by the generation of an undesired coupling mode.

According to the present invention, there is provided a dielectric resonance element which comprises a dielectric member integrally formed and composed of first and second plate portions, which are preferably flat plate portions in a substantially square shape, and which intersect each other with the center lines of the flat plate portions being coincident with each other, wherein TE01δ mode electromagnetic fields of which the electric field vectors are turned in the in-plane directions of the first and second flat plate portions are generated in the first and second flat plate portions, respectively.

The “center line” is defined as the vertical line extending from the intersecting point of the diagonal lines drawn on the upper surface of a flat plate portion having a substantially square shape while the flat plat portion is let to stand upright.

The expression “the center lines are coincident with each other” means that the center lines are completely coincident with each other, and also, the center lines are arranged at the intersecting position of the first and second flat plate portions.

According to the above-described configuration, the outer surfaces of the resonance element are preferably flat, which facilitates the production of the element. Moreover, the resonance element can be used as a dual TE01δ mode resonator. Thus, the aforementioned multi-coupling problems can be avoided, and hence, an undesired frequency response can be prevented.

Preferably, the intersecting angle of the first and second flat plate portions excludes 90°. Thereby, the resonance element functions as a two stage resonator device in which two TE01δ modes are coupled to each other at a predetermined coupling degree. Accordingly, the overall size of the resonance element can be reduced without deterioration of the QU.

Preferably, the thicknesses of the first and second flat plate portions are different from each other. With this configuration, the resonance frequencies of the resonator in the two TE01δ modes become different from each other. Thus, the resonance element can be used as a two TE01δ mode resonator with different resonance frequencies.

Also, preferably, the shapes of the first and second flat plate portions are different from each other. With this configuration, the resonance frequencies of the resonator in the two TE01δ modes become different from each other. Thus, the resonance element can be used as a two TE01δ mode resonator with different resonance frequencies.

Preferably, a comer of the first and second flat plate portions is chamfered or rounded. With this configuration, the resonance frequencies of other undesired modes such as TM modes can be shifted toward the high frequency side to be positioned more distantly from an applied frequency band, while substantially no change occurs in the resonance frequencies of the TE01δ modes. Thereby, the reduction of the Qu of the resonator caused by the affects of the undesired modes can be prevented.

Also, preferably, a hole is formed partially in a side-face of one of the first and second flat plate portions or in both the first and second flat plate portions. With this configuration, the effective dielectric constants of the flat plate portions can be reduced, and hence, the resonance frequencies of the two TE01δ modes can be determined.

Preferably, a hole or a perforation is formed in one of the plane-intersecting portions of the first and second flat plate portions. With this configuration, the resonance frequencies of other undesired modes such as TM modes can be shifted toward the high frequency generation side with respect to the resonance frequencies of the two TE01δ modes. Thereby, reduction of the Qu can be prevented.

Also, preferably, a concavity is formed in a plane-intersecting portion of the first and second flat plate portions. With this configuration, the two orthogonal TE01δ modes are coupled to each other. The coupling degree can be controlled by adjustment of the size of the concavity.

Moreover, preferably, a protuberance is formed in a plane-intersecting portion of the first and second flat plate portions. With this configuration, the two orthogonal TE01δ modes are coupled to each other. The coupling degree can be controlled by adjustment of the size of the protuberance.

Preferably, a supporting stand made of a material having a lower dielectric constant than the dielectric member is joined to one of the side faces perpendicular to the center line of the first and second flat plate portions. With this configuration, the resonance element, when it is placed in a cavity, is positioned more distantly from a conductor surface of the cavity. Thus, the conductor loss can be suppressed. Furthermore, undesired effects of undesired resonance modes such as TM modes or the like can be suppressed. Moreover, the effects on the two TE01δ modes are made to be equal, and thereby, the resonance element can be easily designed.

Also, preferably, a supporting stand made of a material having a lower dielectric constant than the dielectric member is joined to one of the side faces substantially in parallel to the center line of the first and second flat plate portions. With this configuration, the resonance element, when it is placed in a cavity, is positioned more distantly from a conductor surface of the cavity. Thus, the conductor loss can be suppressed. Furthermore, undesired effects of undesired resonance modes such as TM modes or the like can be suppressed.

Also, according to the present invention, there is provided a dielectric resonator which comprises the above-described dielectric resonance element, and a cavity for accommodating the dielectric resonance element. With this configuration, leakage of the electromagnetic fields from the two TE01δ dual mode dielectric resonance element t the outside and undesired coupling to an external circuit can be prevented. Thus, the characteristics of the resonator can be stabilized.

Moreover, according to the present invention, there is provided a filter which comprises the above-described dielectric resonator and an input-output coupling means to be coupled to a predetermined resonance mode of the dielectric resonance element of the dielectric resonator. With this configuration, the filter characteristic with a low insertion loss and a superior electivity can be attained.

Preferably, in the filter, plural dielectric resonance elements are arranged so that the first and second flat plate portions of the plural dielectric resonance elements are not in parallel to the inner walls of the cavity. With this configuration, it is unnecessary to provide a loop for coupling adjacent resonators and a transmission line. Thus, the loss can be reduced, the production efficiency can be enhanced, and the cost can be reduced.

Also, preferably, in the filter, the plural dielectric resonance elements are arranged so that the first flat plate portions or the second flat plate portions of the plural dielectric resonance elements are positioned in the same direction and in the same plane with the center lines being directed in parallel to the upper and lower surfaces of the cavity. With this configuration, propagation of an undesired TM mode can be prevented. Undesirable effects on the attenuation region can be suppressed.

Preferably, in the filter, a dielectric resonance element arranged so that the center line is directed perpendicularly to the upper and lower surfaces of the cavity is combined with the dielectric resonance element arranged so that the center line is perpendicular to the upper and lower surfaces of the cavity. With this configuration, propagation of an undesired TM110 mode can be prevented. A multi-stage filter can be realized.

Also, preferably, in the filter, a single mode resonance element such as a TE01δ single mode resonator and a TEM semi-coaxial cavity resonator is combined with the dielectric resonance element arranged so that the center line is directed in parallel to the upper and lower surfaces of the cavity. With this configuration, propagation of the undesired TM110 mode can be prevented.

Also, according to the present invention, there is provided an oscillator device which comprises two sets of oscillators, each set containing a line, a positive element connected to one end of the line, and a dielectric resonance element connected to an intermediate point of the line, wherein the dielectric resonance elements are ones defined in any one of claims 1 to 12 and disposed on a substrate having the lines and the positive elements formed thereon, and electromagnetic fields of two coupling modes, that is, an odd mode and an even mode, generated between two TE01δ modes of the dielectric resonance elements are coupled to the lines of the two sets of oscillators, respectively. With this configuration, a resonator device which uses the single dielectric resonance element to reduce the size of the device and can output oscillation signals with two different frequencies can be formed.

Preferably, in the above-described filter, the lines contained in the two sets of oscillators are arranged substantially in parallel to each other, and the dielectric resonance elements are arranged so that the center lines of the dielectric members which function as the dielectric resonance elements are in parallel to the substrate, and the magnetic fields in the odd mode and the even mode are coupled to the lines in the two sets of oscillators, respectively. With this configuration, the lines and the whole oscillator can be easily arranged on the substrate.

Also, according to the present invention, there is provided a communication device which comprises the dielectric resonator, the filter, and the oscillator device. Thereby, a communication device which is small and light in size and weight, and has a high power efficiency and a high sensitivity communication performance can be realized.

### BRIEF DESCRIPTION OF THE DRAWINGS

FIGS. 1A to 1F show a configuration of a dielectric resonance element according to a first embodiment of the present invention;

FIGS. 2A to 2c show a configuration of a dielectric resonance element according to a second embodiment of the present invention;

FIGS. 3A to 3B show a configuration of a dielectric resonance element according to a third embodiment of the present invention;

FIGS. 4A to 4D show a configuration of a dielectric resonance element according to a fourth embodiment of the present invention;

FIGS. 5A to 5D show a configuration of a dielectric resonance element according to a fifth embodiment of the present invention;

FIG. 6 shows a configuration of a dielectric resonance element according to a sixth embodiment of the present invention;

FIG. 7 shows a configuration of a dielectric resonance element according to a seventh embodiment of the present invention;

FIGS. 8A and 8B show examples of electromagnetic field distributions in two TE01δ modes and even and odd modes as the coupling modes thereof which are relevant to an eighth embodiment of the present invention;

FIGS. 9A to 9D are perspective views showing the configurations of dielectric resonance elements by which two TE01δ modes are coupled to each other;

FIGS. 10A to 10D are perspective views showing the configurations of dielectric resonance elements by which tow TE01δ modes are coupled to each other according to a ninth embodiment of the present invention;

FIGS. 11A and 11B illustrate the configurations of dielectric resonator units according to a tenth embodiment of the present invention;

FIG. 12 illustrates the configuration of a dielectric resonator unit according to an eleventh embodiment of the present invention;

FIGS. 13A and 13B illustrate the configuration of a filter according to a twelfth embodiment of the present invention;

FIGS. 14A and 14B illustrate the configuration of a filter according to a thirteenth embodiment of the present invention;

FIGS. 15A and 15B illustrate the configuration of a filter according to a fourteenth embodiment of the present invention;

FIGS. 16A and 16B illustrate the configuration of a filter according to a fifteenth embodiment of the present invention;

FIGS. 17A and 17B show an example of the electromagnetic field of a TM110z mode;

FIGS. 18A and 18B illustrate the configuration of a filter according to a sixteenth embodiment of the present invention;

FIGS. 19A and 19B illustrate the configuration of a filter according to a seventeenth embodiment of the present invention;

FIG. 20 is a perspective view of an oscillator device according to an eighth embodiment of the present invention;

FIG. 21 is an equivalent circuit diagram of one set of oscillator unit contained in the oscillator device;

FIG. 22 is a block diagram showing the configuration of a communication device according to a ninth embodiment of the present invention;

FIGS. 23A and 23B show the positional relationship between the resonance modes of dielectric resonance elements and two lines; and

FIGS. 24A and 24B show the positional relationship between the resonance modes of dielectric resonance elements and two lines.

### DESCRIPTION OF THE PREFERRED EMBODIMENTS

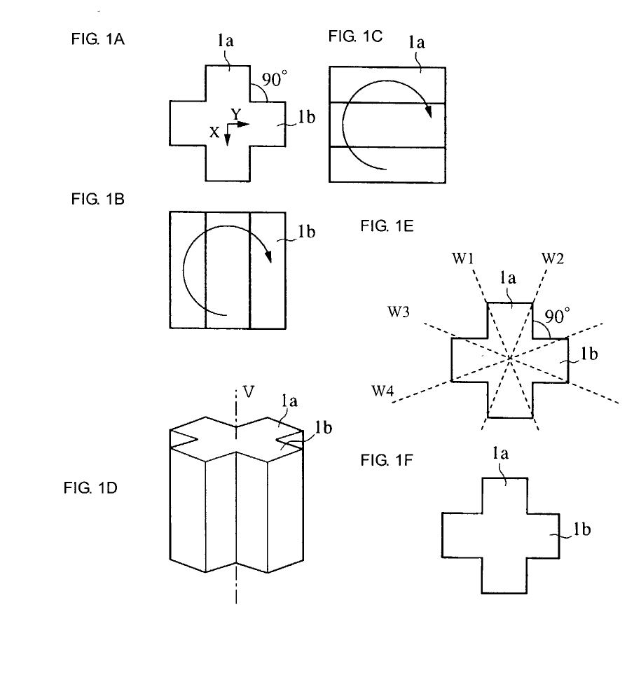

The configuration of a dielectric resonance element according to a first embodiment will be described with reference to FIGS. 1A to 1F.

FIG. 1A is a plan view of the dielectric resonance element, FIG. 1B is a front view thereof, FIG. 1C is a right-side view thereof, and FIG. 1D is a perspective view thereof.

The dielectric resonance element is formed by integrally forming a dielectric material into such a shape that a first flat plate portion 1a and a second flat plate portion 1b each preferably having a substantially square-shape are intersected by each other with the center lines thereof (dashed line V in FIG. 1D) being coincident with each other. In this example, the intersecting angle of the first and second flat plat portions is set at 90°.

Here, the center lines are defined as the vertical line extended from the intersecting point of the diagonal lines W1 and W2 drawn on the upper surface of the first flat plate portion 1a and as the vertical line extended from the intersecting point of the diagonal lines W3 and W4 drawn on the upper surface of the first flat plate portion 1b.

Preferably, the center line of the first flat plate portion 1a and that of the second flat plate portion 1b are extended so as to be completely coincident with each other. However, both center lines may be shifted from each other, provided that the lines are present in the intersection-portion of the dielectrics of the first flat plate portion 1a and the second flat plate portion 1b, as shown schematically and exaggeratedly in FIG. 1F.

The axis on which the first flat plate portion 1a is extended perpendicularly to the center line is taken as an X-axis, while the axis on which the second flat plate portion 1b is extended perpendicularly to the center line is taken as a Y-axis.

In the first flat plate portion, a TE01δy mode as a resonance mode in which an electric field vector is turned in the in-plane direction as shown by arrow (C) is generated. Similarly, a TE01δx mode as a resonance mode in which an electric field vector is turned in the in-plane direction as shown by arrow (B) is generated. In this example, the first and second flat plate portions are perpendicular to each other, so that the two TE01δ modes are perpendicular to each other and not coupled. Accordingly, the dielectric resonance element can be operated as two resonators independent of each other.

This dielectric resonance element has a shape mainly comprising flat planes as a whole, and has a columnar shape extending in the center line direction. Therefore, the integral formation of a dielectric material can be easily performed. Thus, the production cost can be reduced. Moreover, since there is no space which allows a third resonance mode to generate, undesired coupling to the third resonance mode is prevented from being generated.

It should be noted that the center line of the dielectric resonance element drawn by the dashed line in FIG. 1D will not be shown in the drawings referenced in the following description of the embodiments, if the representation thereof is not necessary, to prevent the drawings from becoming complicated.

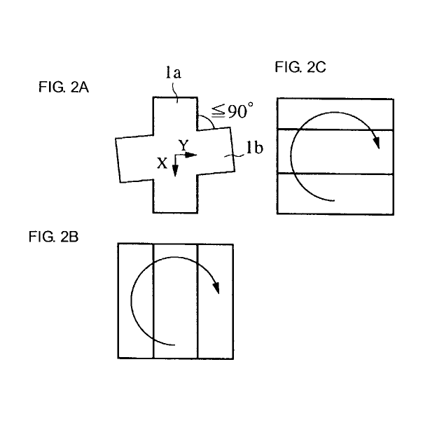

FIGS. 2A to 2C show the configuration of a dielectric resonance element according to a second embodiment of the present invention. FIG. 2A is a plan view of the dielectric resonance element, FIG. 2B is a front view thereof, and FIG. 2c is a right-side view thereof. In this example, the intersecting angle between the first and second flat plate portions 1a and 1b is preferably set at an angle less than 90°, which is different from that of the example of FIGS. 1A to 1F. According to this configuration, a vector component in the in-plane direction of the first flat plate portion 1a is produced in the TE01δx mode electric field vector which is generated in the in-plane direction of the second flat plate portion 1b. Therefore, the TE01δs mode and the TE01δy mode are coupled to each other. The more the intersecting angle between the first and second flat plate portions 1a and 1b departs from 90°, the larger the coupling degree between both modes becomes.

When the first flat plate portion 1a is extended in the X-axial direction, the extension direction of the second flat plate portion 1b departs from the Y-axial direction. Thus, the resonance mode in which the electric field is turned in the in-plane direction of the second flat plate portion 1b is not a TE01δx mode, but such a resonance mode as may be called a pseudo TE01δx mode.

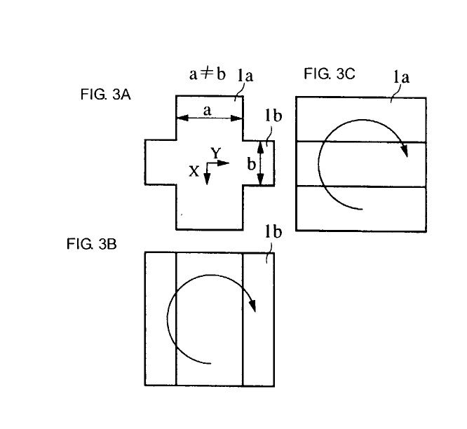

FIGS. 3A to 3C show the configuration of a dielectric resonance element according to a third embodiment of the present invention. In the example of FIGS. 1A to 1F, the thicknesses of the first and second flat plate portions 1a and 1b are set to be equal. In the example of FIGS. 3A to 3C, the thickness a of the first flat plate portion 1a is set to be larger than the thickness b of the second flat plate portion 1b. According to this configuration, the resonance frequency in the TE01δy mode in which the electric field vector is turned in the in-plane direction of the first flat plate portion 1a is lower than the resonance frequency in the TE01δx mode in which the electric field vector is turned in the in-plane direction of the second flat plate portion 1b. That is, this dielectric resonance element acts as two-independent resonators with different resonance frequencies which are independent of each other.

For example, when an input-output coupling means such as a coupling loop is provided to form a filter, the resonance frequency is increased due to the reduction of a resonance space caused by the effects of the input-output means. Thus, the above-described configuration can be used to correct the increase of the resonance frequency.

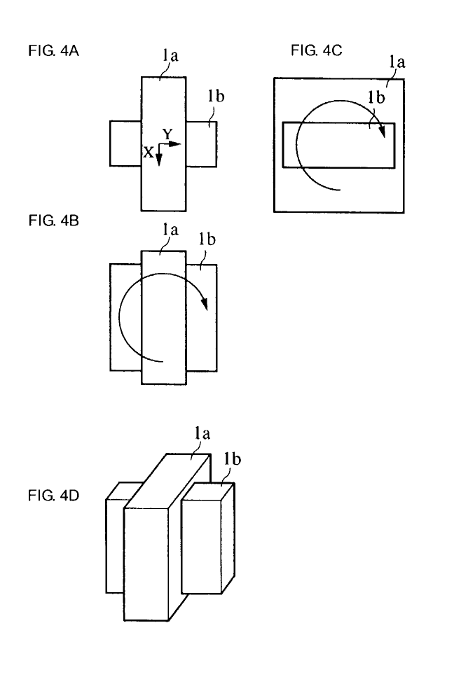

FIGS. 4A to 4D show the configuration of a dielectric resonance element according to a fourth embodiment of the present invention. In the example of FIGS. 1A to 1F, the shapes and sizes of the first and second flat plate portions 1a and 1b are formed so as to be substantially equal. On the other hand, in the example of FIGS. 4A to 4D, the second flat plate portion 1b is formed so as to be smaller, to some degree, that the first flat plate portion 1a. Thereby, the resonance frequency in the TE01δx mode generated in the second flat plate portion 1b can be set to be higher than that in the TE01δy mode generated in the first flat plate portion 1a. That is, the dielectric resonance element acts as two-resonators with different resonance frequencies which are independent of each other.

This configuration can be also used to correct the increase of a resonance frequency caused by the effects of an input-output coupling means such as a coupling loop employed when a filter is formed or the like.

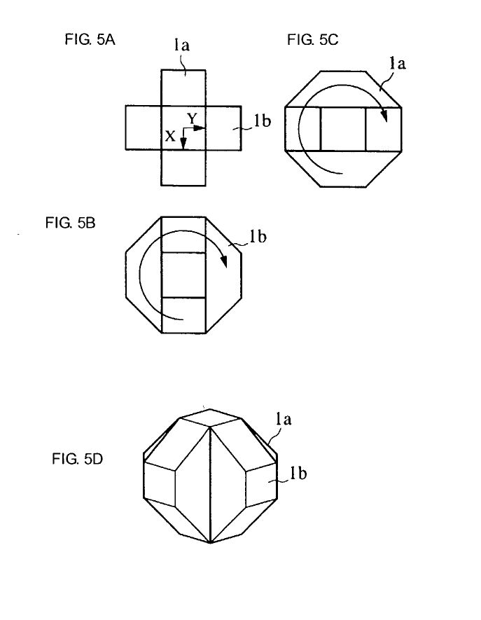

FIGS. 5A to 5D show the configuration of a dielectric resonance element according to a fifth embodiment of the present invention. FIG. 5A is a plan view of the dielectric resonance element, FIG. 5B is a front view thereof, FIG. 5C is a right-side view thereof, and FIG. 5D is a perspective view thereof.

This dielectric resonance element has the same shape and size as that obtained by chamfering the four corners of the first and second flat plate portions 1a and 1b having the configuration of FIGS. 1A to 1F. According to this chamfer-configuration, the resonance frequency in the TM110x mode or in the TM110y mode in which the electric field vector is turned in the X- or Y-axial direction is shifted toward the high frequency side. Accordingly, the resonance frequencies in these undesired modes are shifted to frequencies which do not influence the resonance frequencies of the TE01δx mode and the TE01δy mode. Hence, reduction of the Qu can be prevented.

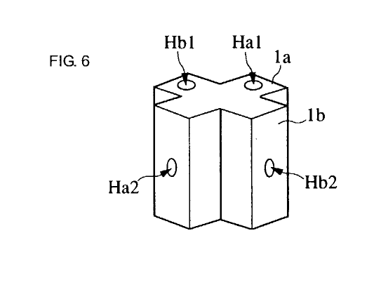

FIG. 6 is a perspective view of the configuration of a dielectric resonance element according to a sixth embodiment of the present invention. The outer configuration thereof is similar to that of FIGS. 1A to 1F. However, in this example of FIG. 6, holes are formed in predetermined positions of the first and second flat plate portions 1a and 1b. That is, a hole Ha1 is formed in the upper surface of the first flat plate portion 1a, and a hole Ha2 is formed in the side face thereof. Moreover, a hole Hb1 is formed in the upper surface of the second flat plate portion 1b, and a hole Hb2 is formed in the side face thereof.

The resonance frequencies in the TE01δ modes in which the electric field vectors are turned in the in-plane direction of the flat plate portions can be increased by partially removing the dielectric material of the flat plate portions as described above. Accordingly, the deeper the holes, or the larger the inner diameters of the holes, the higher the resonance frequencies in the TE01δ modes can be set.

The resonance frequencies can be finely adjusted so as to increase and decrease by configuring the dielectric resonance element so that dielectric rods can be inserted in or extracted from the holes, respectively. Thus, after the dielectric resonance element is built-in as a resonator or filter, the characteristics thereof can be adjusted.

In FIG. 6, the holes Ha1 and Hb1 may be formed so as to extend through the dielectric resonance element and reach the bottom surface thereof. Moreover, the holes Ha2 and Hb2 may be formed so as to extend through the element and reach the opposite side faces thereof, respectively.

Since the holes are extended in the plane directions of the dielectric flat plate portions, the holes formed in one flat plate portion exert no influences over the TE01δ mode generated in the other flat plate portion orthogonal to the flat plate portion having the holes formed therein. Hence, the two TE01δ modes can be adjusted independently of each other.

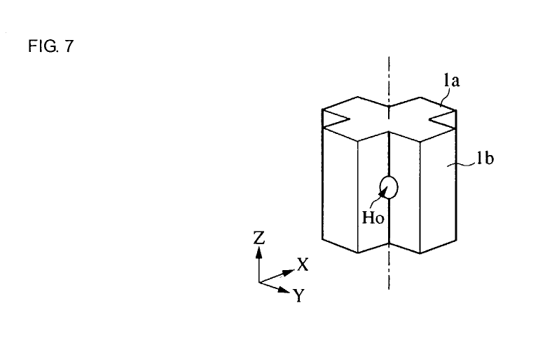

FIG. 7 is a perspective view of the configuration of a dielectric resonance element according to a seventh embodiment of the present invention.

In this example, a hole Ho is formed so as to extend from one plane-intersecting part of the first and second flat plate portions 1a and 1b to the opposite plane-intersecting part with the center line drawn by a dashed line being interposed between the plane-intersecting parts in FIG. 7.

The central portion of the dielectric resonance element is a region in which the electric field components in the TE01δ modes generated in the two flat plate portions are small but is a region in which the electric field components in the TM110x mode of which the electric field is directed in the X-axial direction, in the TM110y mode of which the electric field is directed in the Y-axial direction, and in the TM110z mode of which the electric field is directed in the Z-axial direction are high. The resonance frequencies in the three TM110 modes can be shifted toward the high frequency side where less influences are given to an applied frequency band, while no influences are exerted over the resonance frequencies in the two TE01δ modes, since the hole is provided in the center of the dielectric resonance element.

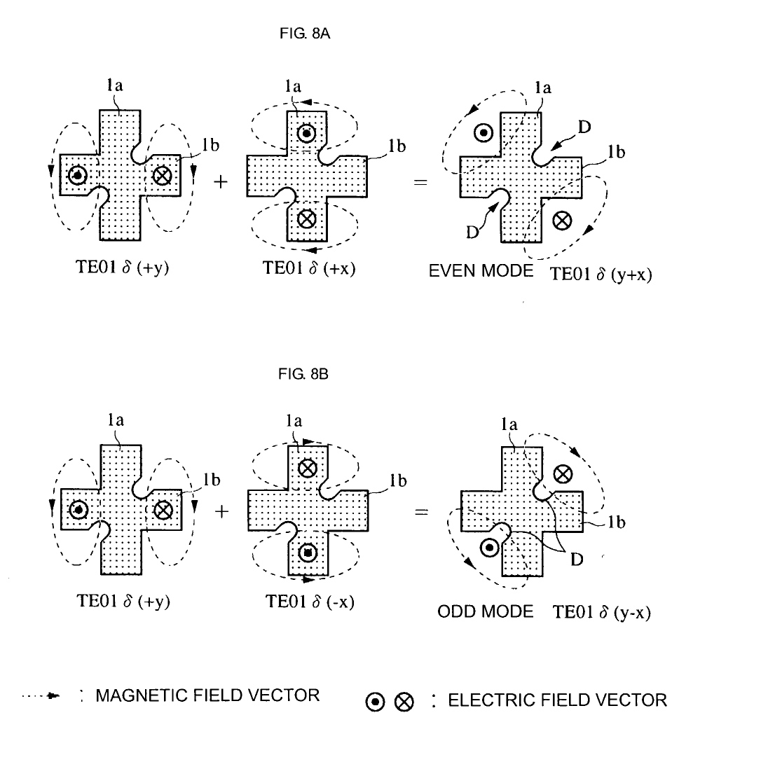

Hereinafter, according to an eighth embodiment of the present invention, the method of coupling the two TE01δ modes and the coupling mode will be described with reference to FIGS. 8A and 8B.

FIG. 8A shows the TE01δ (+y) mode, the TE01δ (+x) mode, and the even mode produced by combining both modes. Moreover, FIG. 8B shows the TE01δ (y) mode, the TE01δ (−x) mode, and the odd mode produced by combining both modes. When the shapes and sizes of the first and second flat plate portions 1a and 1b are equal to each other, the resonance frequencies in the TE01δx mode and the TE01δy mode are equal to each other. Accordingly, the frequencies of the even mode and the odd mode thereof are equal to each other. Thus, when a concavity D extending toward the center is formed in the plane-crossing portion of the first and second flat plate portions, the symmetry of the even mode and the odd mode is broken. Thus, a difference can be given between the frequencies in the number and odd modes.

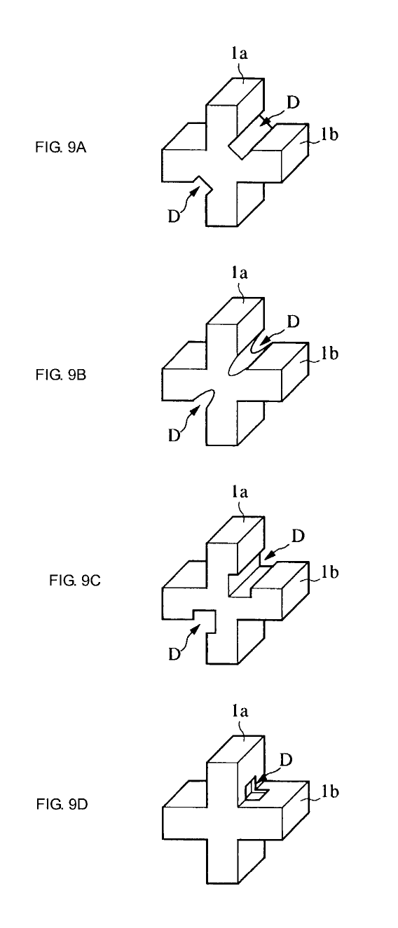

FIGS. 9A to 9B are perspective views of dielectric resonance elements provided with the concavities of which the shape and sizes are different from those of the above-described concavity.

In the example of FIG. 9A, a groove-shaped concavity D having a constant width is formed in the plane-intersecting part of the first and flat plate portions 1a and 1b so as to extend toward the center line. The cross-section of the concavity may be optional as shown in FIGS. 9B and 9C. Also, as shown in FIG. 9D, a concavity D is not necessarily extended in the direction parallel to the center line, and may be formed partially in the plane-intersecting part.

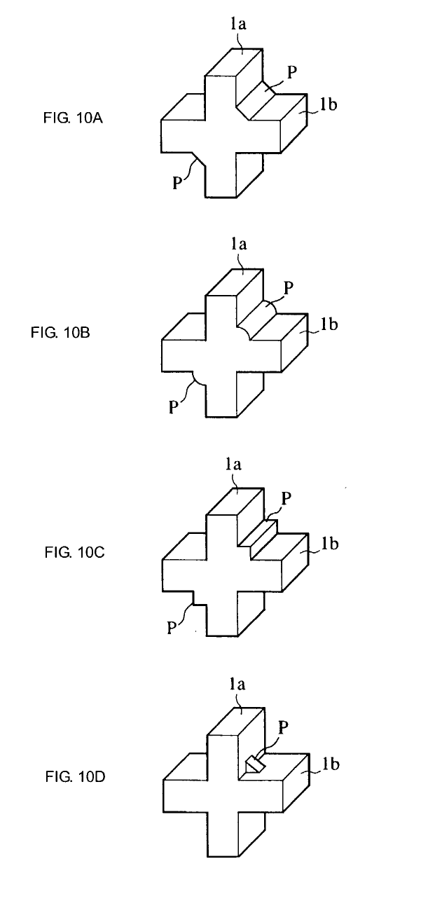

FIGS. 10A to 10D show a configuration for coupling the two TE01δ modes and another configuration for making the resonance frequencies in the coupling modes (the even mode and the odd mode) different from each other according to a ninth embodiment of the present invention.

In the examples of FIGS. 8A, 8B, and 9A to 9D, the concavities are formed in the plane-intersecting parts of the two flat plate portions, respectively. On the other hand, in the examples of FIG. 10A to 10D, each protuberance P which protrudes away from the center line is formed on the two plane-intersecting parts. The resonance frequencies in the even and odd modes become different from each other, so that the TE01δx mode and the TE01δy mode can be coupled to each other. In addition, the even and odd modes with different frequencies can be utilized.

Hereinafter, the fixing structure of the dielectric resonance element will be described.

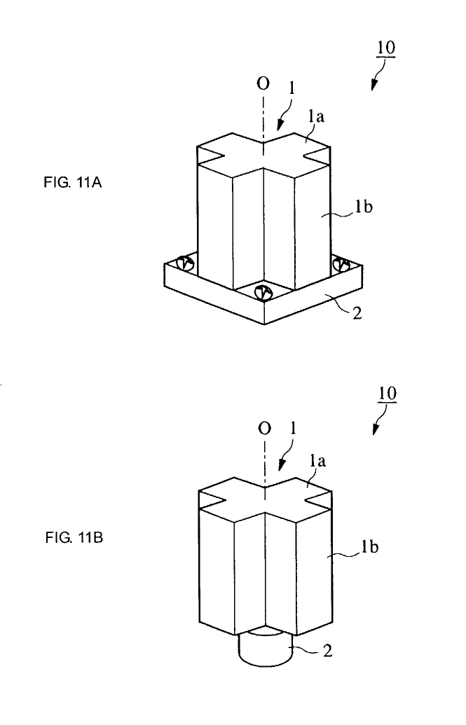

FIGS. 11A and 11B show the configuration of a dielectric resonator unit according to a tenth embodiment by which dielectric resonance elements having different shapes can be fixed in cavities or the like. In the example of FIG. 11A, a supporting stand 2 is joined to one side face of the first and second flat plate portion 1a and 1b, which is perpendicular to the center line O. The dielectric constant of the supporting stand 2 is preferably lower than that of each of the first flat plate portions 1a and 1b, and thereby, influences given to the resonance modes of the resonance element are reduced.

As shown in the drawings, the four comers of the supporting stand 2 are screwed to the inner bottom of a cavity. Thus, the dielectric resonator unit can be easily fixed in the cavity.

In the example of FIG. 11B, a supporting stand 2 having a columnar shape is provided, of which the joint area for the side face of the first and second flat plate portion 1a and 1b is reduced. According to this configuration, the effects of the supporting stand 2 on the resonance modes can be suppressed. In the example of FIG. 11B, the bottom of the supporting stand 2 is joined to the inner bottom or the like of a cavity, and thus, the dielectric resonance element is supported at a predetermined position in the cavity.

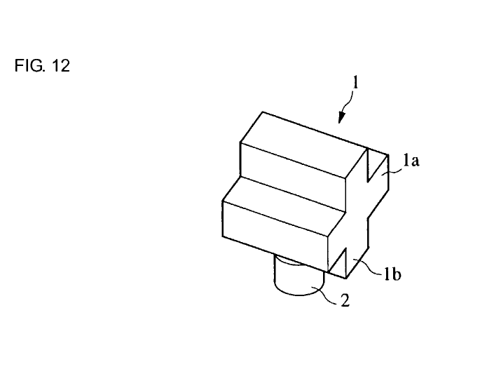

FIG. 12 shows the configuration of a dielectric resonator unit according to an eleventh embodiment of the present invention. In this example, the supporting stand 2 is joined to one side face of the second flat plate portion 1b. The even mode and the odd mode of the dielectric resonance element can be magnetically coupled to two lines on a substrate, due to the supporting structure of FIG. 12 as described below.

It should be noted that concavities and protuberances for coupling the two resonance modes, holes for adjusting the frequencies, and the like are not shown in the examples of FIGS. 11A, 11B, and 12.

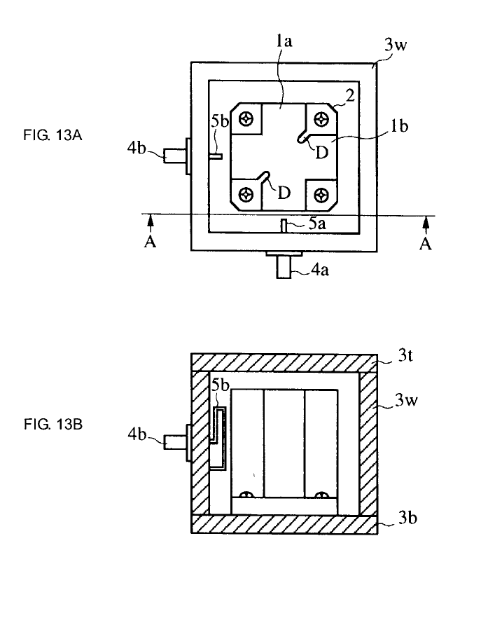

Hereinafter, the configuration of a filter according to an eleventh embodiment of the present invention will be described with reference to FIGS. 13A and 13B.

The filter comprises different kinds of the above-described dielectric resonance elements accommodated in a cavity and an input-output coupling means for coupling into a predetermined resonance mode.

FIG. 13A is a plan view of the filter having an upper lid 3t removed therefrom. FIG. 13B is a cross-section taken on line A-A of FIG. 13A. In FIG. 13B, the bottom plate 3b and the side wall 3W of a cavity are shown. The dielectric resonator unit having the structure of FIG. 11A is screwed to the bottom plate 3b of the cavity.

Coaxial connectors 4a and 4b are shown in FIGS. 13A and 13B. Coupling loops 5a and 5b are provided between the center conductors and the cavity side wall, respectively. The coupling loop 5a is coupled to the magnetic field in the TE01δx mode, as shown in FIG. 8. Similarly, the coupling loop 5b is magnetic-field coupled to the TE01δy mode. Concavities D are formed in the dielectric resonance element. Therefore, the TE01δx mode and the TE01δy mode are coupled to each other. Thus, the filter function as a filter comprising two stage resonators coupled to each other to have a band-pass characteristic.

The bottom plate 3b, the side wall 3w, and the upper lid 3d of the cavity shown in FIGS. 13A and 13B are preferably made of metal such as A1 and formed by die-casting, respectively, or these members of the cavity are formed by providing an electroconductive coat onto a ceramic or resin.

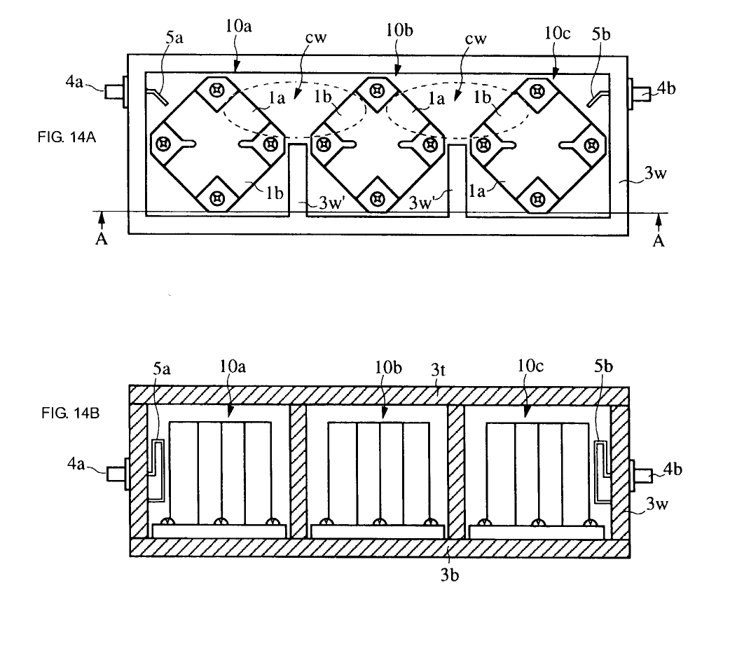

FIGS. 14A and 14B show the configuration of a filter using three dielectric resonance elements according to a thirteenth embodiment of the present invention. FIG. 14A is a plan view of the filter having the upper lid 3t of the cavity removed therefrom. FIG. 14B is a cross-section taken on line A-A of FIG. 14A. Dielectric resonator units 10a, 10b, and 10c comprising the dielectric resonance elements fixed to the respective supporting stands are shown in FIG. 14. In this example, the first and second flat plate portions 1a and 1b of each dielectric resonance element are arranged at an angle of 45° to the arrangement direction of the dielectric resonator units 10a, 10b, and 10c. Further, partial walls 3w′ are provided between adjacent dielectric resonator units, respectively. The apertures of the side walls function as coupling windows cw through which predetermined resonators of the adjacent dielectric resonator units are coupled to each other.

Through the coupling windows cw, the TE01δy mode caused by the flat plate portion 1a of the dielectric resonator unit 10a is magnetic-field coupled with the TE01δx mode by the flat plate portion 1b of the dielectric resonator unit 10b, and moreover, the TE01δy mode caused by the flat plate portion 1a of the dielectric resonator unit 10b is magnetic-field coupled with the TE01δx mode by the flat plate portion 1b of the dielectric resonator unit 10c. Accordingly this filter functions as a filter comprising the total six-stage resonators sequentially coupled and having a bandpass characteristic.

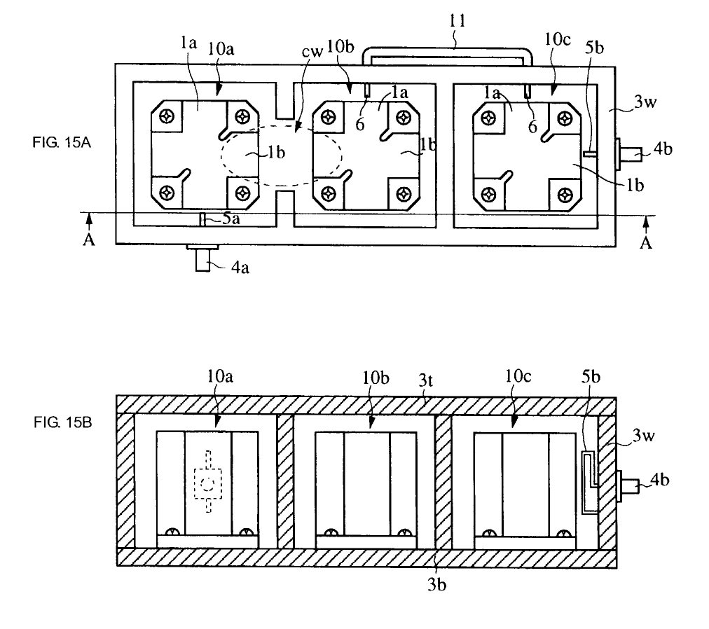

FIGS. 15A and 15B show the configuration of a filter comprising three dielectric resonator units according to a fourteenth embodiment of the present invention. In this example, the three dielectric resonator units 10a, 10b, and 10c are arranged in such a manner that the first flat plate portions la are positioned in parallel to each other, and the second flat plate portions 1b are positioned in the same plane-direction. Moreover, a coupling window cw is formed by means of side walls of the cavity between the dielectric resonator units 10a and 10b. The TE01δx modes caused by the second flat plate portions 1b of the dielectric resonator units 10a and 10b are magnetic-field coupled with each other.

Coupling loops 6 to be coupled to the TE01δy modes caused by the first flat plate portions 1a of the respective dielectric resonator units 10b and 10c are provided in the cavity. The two coupling loops 6 are connected to each other by means of a line 11. Moreover, a coupling loop 5a of for a coaxial connector 4a is arranged so as to be magnetic-field coupled to the TE01δy mode caused by the first flat plate portion 1a of the dielectric resonator unit 10a. A coupling loop 5b for a coaxial connector 4b is arranged so as to be magnetic-field coupled to the TE01δx mode by the second flat plate portion 1b of the dielectric resonator unit 10c.

According to the above-described configuration, this filter functions as a filter comprising a total of six resonators sequentially coupled to each other and having a pass-band characteristic.

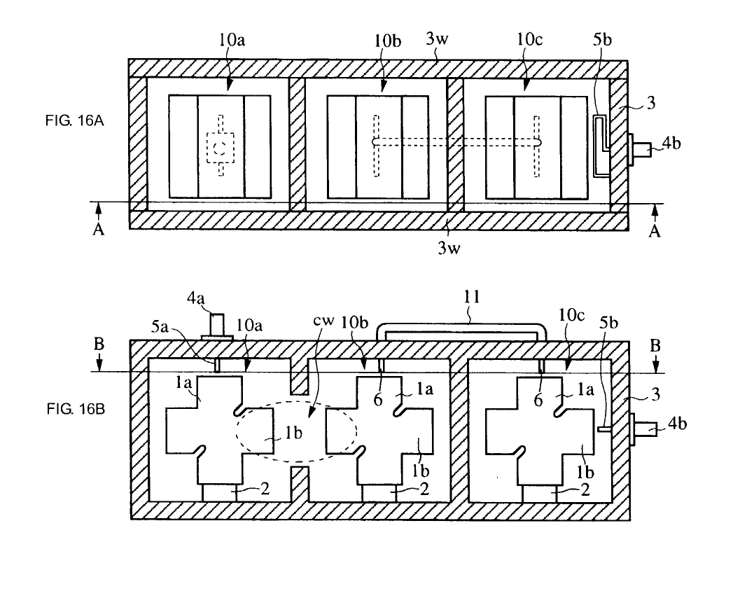

FIGS. 16A and 16B show the configuration of a filter using dielectric resonator units according to a fifteenth embodiment of the present invention. FIG. 16A is a cross-section taken on line B-B of FIG. 16B, and FIG. 16B is a cross-section taken on line A-A of FIG. 16A. In these drawings, a cavity body 3 comprising three spaces through which a wave propagates, and side walls 3w of the cavity covering openings on both sides of the cavity body 3 are shown.

The relative positional relationship between the three dielectric resonator units 10a, 10b, and 10c, the coupling window cw, and the coupling loops 5a, 5b, and 6 shown in FIGS. 16A and 16B is equivalent to that of FIGS. 15A and 15B. Thus, the filter in which the supporting stands 2 are joined to the side faces of the first or second flat plate portions of the dielectric resonance elements and fixed to the cavity body 3 is electrically the same as that of FIGS. 15A and 15B.

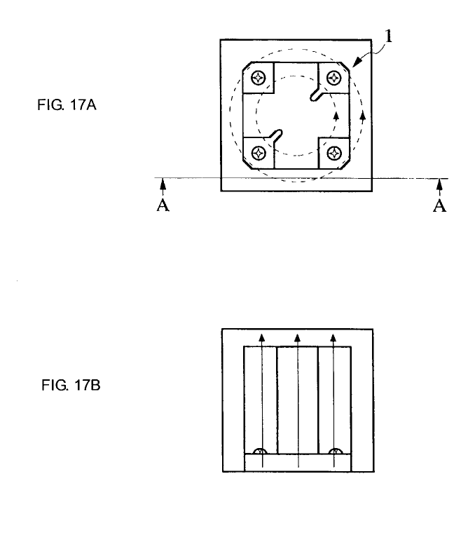

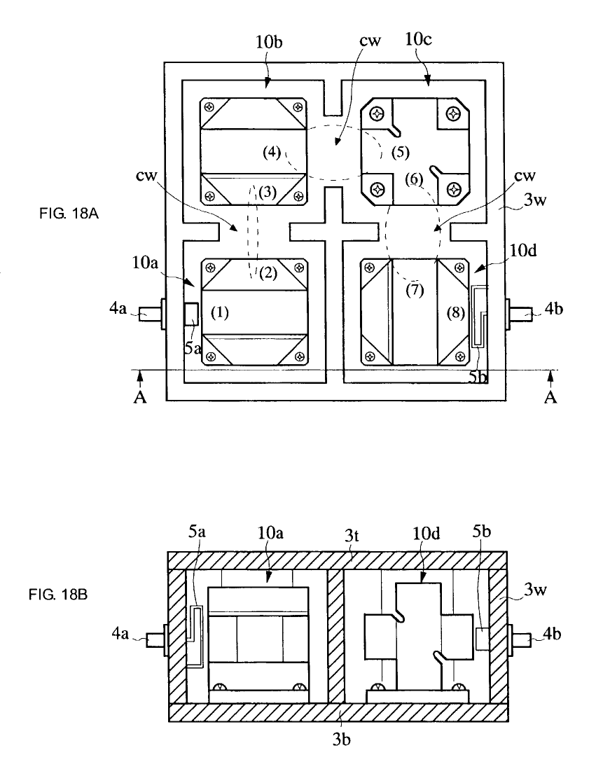

Hereinafter, the configuration of a filter according to a sixteenth embodiment of the present invention will be descried with reference to FIGS. 17A, 17B, 18a, and 18B.

FIGS. 17A and 17B show an example of an electromagnetic field distribution of a TM110z mode. FIG. 17A is a plan view of a dielectric resonance element in a cavity. FIG. 17B is a front view taken on line A-A of FIG. 17A. In the drawings, the cavity is shown only by the wall surface.

In FIGS. 17A and 17B, the solid line arrows represent electric field vectors in the Z-axial direction, and the broken line arrows represent magnetic field vectors which turn in the plane (x-y plane) perpendicular to the Z-axis.

For the TM110z mode, the magnetic field is more spread than that of the TE01δ mode which is positively used. Therefore, the adjacent resonator is ready to be coupled in the TM110z mode, so that the TM110z mode can be easily propagated. If the TM110z mode is not sufficiently distant from the TE01δ mode, the attenuation region of the filter may be affected by the TM110z mode.

FIGS. 18A and 18B show a filter having a configuration which is effective in solving the above-described problems. FIG. 18A is a plan view of the filter having the upper lid 3d of the cavity removed therefrom. FIG. 18B is a cross-section taken on line A-A of FIG. 18A. In FIGS. 18A and 18B, the bottom plate 3b of the cavity and the side walls 3w of the cavity are shown. The dielectric resonator units 10a to 10d having the same configurations as those of FIGS. 11A, 11B, and 12 are screwed to be fixed to the bottom plate 3b of the cavity. In this example, for the dielectric resonator units 10a, 10b, and 10d, the four corners of the first flat plate portions 1a or the second flat plate portions 1b of the dielectric resonance elements are chamfered, respectively.

The three dielectric resonator units 10a, 10b, and 10d are arranged so that the center lines of the two flat plate portions of the respective dielectric resonance elements are in parallel to the bottom plate 3b and the upper lid 3t of the cavity. The dielectric resonator unit 10c is arranged so that the center lined is perpendicular to the bottom plate 3b and the upper lid 3t of the cavity.

As shown in FIG. 18A, the coupling windows cw are formed in the side walls 3w of the cavity between the dielectric resonator units 10a and 10b, 10b and 10c, and 10c and 10d, respectively. The numbers (1) to (8) given to the respective flat plate portions of the dielectric resonator units are the ordinal numbers representing the stages of the resonators comprising the flat plat portions, respectively. The first and second stage resonators, the third and fourth stage resonators, the fifth and sixth stage resonators, and the seventh and eighth stage resonators are coupled to each other, due to the concavities formed in the dielectric resonance elements. The second and third stage resonators, the fourth and fifth stage resonators, and the sixth and seventh stage resonators are magnetic-field coupled to each other through the coupling windows cw, respectively. Moreover, the first stage resonator (1) is coupled to the coupling loop 5a, and the eighth stage resonator (8) is coupled to the coupling loop 5b.

The TM110z mode generated in the dielectric resonator unit 10c can not be propagated to the adjacent dielectric resonator units 10b and 10d. Also, the TM110z modes are generated in the dielectric resonator units 10b and 10d. However, each effective dielectric constant in the Z-direction is low compared to that of the dielectric resonator unit 10c. Thus, the frequency of the TM110z mode in the respective dielectric resonance elements 10b and 10d is at least 1.3 times higher than that of the TM110z mode in the dielectric resonator unit 10c. Therefore, coupling of the TM110z mode is suppressed. As a result, even if the frequency of the TM110z mode generated in the dielectric resonator unit 10c is near that of the TE01δ mode to be used, the attenuation characteristic of the filter is not undesirably affected.

In the example of FIGS. 18A and 18B, all of the dielectric resonator units 10a to 10d are fixed to the bottom plate 3b of the cavity. The dielectric resonator units having the structures shown in FIG. 11A and 11B may be used. The dielectric resonator units 10a, 10b, and 10d may be screwed to the side walls of the cavity. According to this structure, air layers are provided on the upper and lower sides of the dielectric resonator units 10a, 10b, and 10d. Accordingly, the frequency of the TM110z mode is further increased, so that propagation of the TM110z mode is more suppressed.

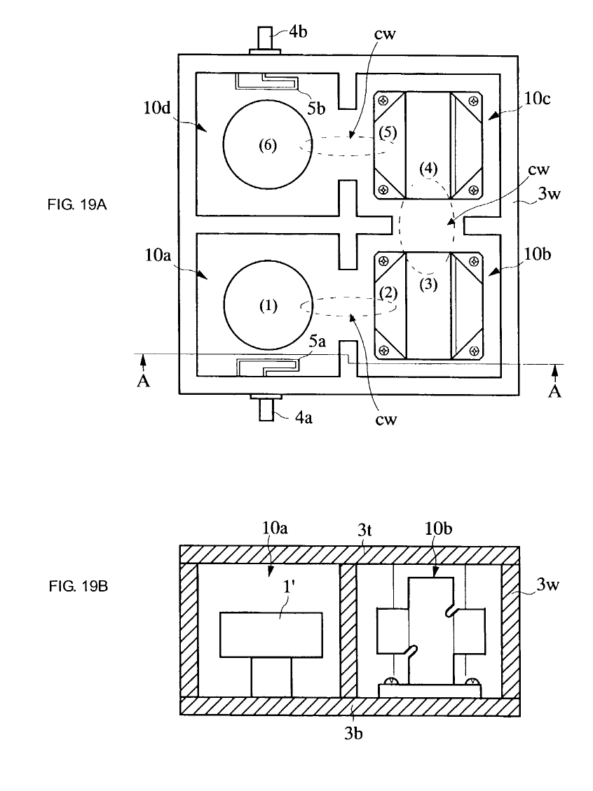

FIGS. 19A and 19B show the configuration of a filter according to a seventeenth embodiment of the present invention. FIG. 19A is a plan view of the filter having the upper lid 3d of the cavity removed therefrom. FIG. 19B is a cross-section taken on line A-A of FIG. 19A. In FIG. 19A, the bottom plate 3b of the cavity and the side walls 3w thereof are shown. In this example, as the dielectric resonator units 10a and 10d, resonators each having a general TE01δ single mode and comprising a columnar dielectric resonator 1′ are formed. The coupling windows cw are formed in the cavity side walls 3w between the dielectric resonator units 10a and 10b, 10b and 10c, and 10c and 10d, respectively. Propagation of the TM110z mode can be further suppressed by forming the filter containing the TE01δ single mode resonators as described above.

In the example of FIGS. 19A and 19B, as the single mode resonators, TEM semi-coaxial cavity resonators may be provided. Thereby, propagation of the TM110z mode can be also suppressed.

In the example of FIGS. 18A, 18B, 19A, and 19B, the supporting stands of the dielectric resonance elements are fixed directly to the bottom plate of the cavity. Spacers such as washers or the like may be inserted between the supporting stands and the bottom plate of the cavity to form air-layers. Thereby, the frequency of the TM110z mode can be increased. Thus, the frequency can be set to be further distant from that of the TE01δ mode for use.

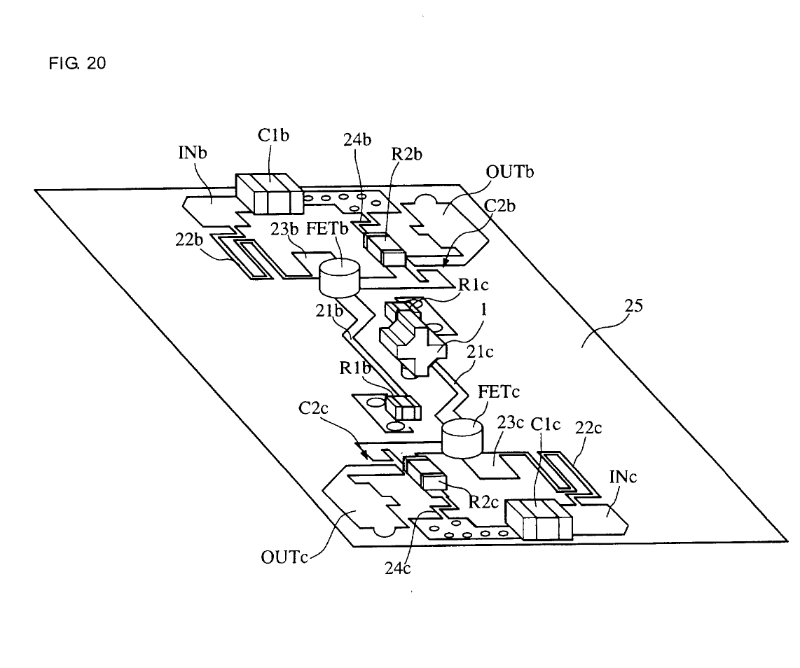

Hereinafter, the configuration of an oscillator device according to an eighteenth embodiment of the present invention will be described with reference to FIGS. 20, 21, 23A, 23B, 24A, and 24B.

FIG. 20 is a perspective view showing the appearance of the oscillator device formed on a substrate. Lines 21b to 24b and lines 21c to 24c are formed on the upper surface of a substrate 25, respectively. Furthermore, FETb, FETc, chip resistors R1b, R2b, R1c, and R2c, and chip capacitors C1b and C1c are mounted onto the upper surface of the substrate 25. Moreover, a dielectric resonance element 1 is fixed to the upper surface of the substrate 25 via a supporting stand.

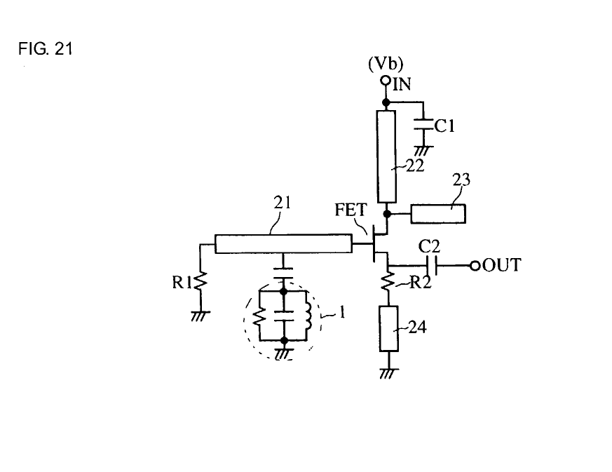

FIG. 21 is an equivalent circuit diagram of a set of oscillator units contained in the oscillator device shown in FIG. 20. The reference numerals in FIG. 21 correspond to those in FIG. 20, respectively. A line 21 is terminated at a resistor R1 in one end thereof, and is connected to the gate of FET in the other end thereof. A bias voltage application circuit comprising a line 22 and a capacitor C1 is connected to the drain of the FET. Vb is a bias voltage. The source of the FET is grounded via a resistor R2 and a line 24. A line 23 as a stub is connected to the drain of the FET. An oscillation signal can be output from the source of the FET via a capacitor C2.

The dielectric resonance element 1 is connected to a predetermined position in the line 21. Thus, an oscillation circuit of band-reflection type as a whole is formed.

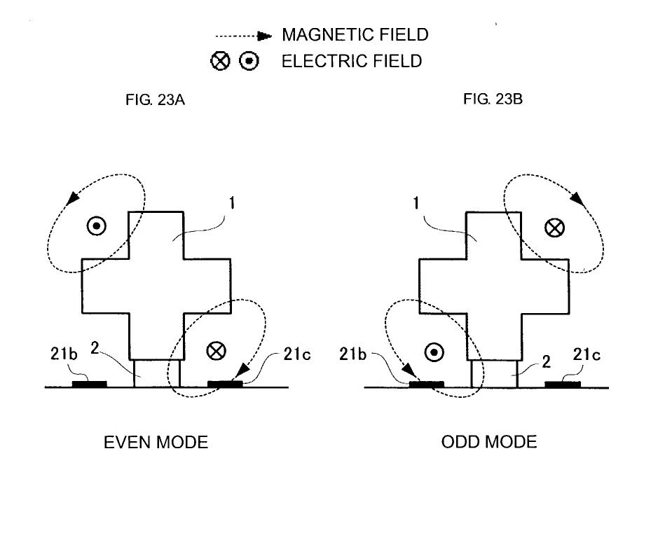

The oscillator device shown in FIG. 20 is provided with two sets of oscillators shown in FIG. 21. The single dielectric resonance element 1 is mounted onto the substrate 25, and the circuit is arranged symmetrically with respect to the mounting position as a center point. The dielectric resonance element 1 has the same configuration as that shown in FIGS. 8A and 8B excepting that a protuberance is provided instead of the concavity. In particular, the dielectric resonance element 1 functions as two resonators with a TE01δ (y+x) mode and a TE01δ (y−x) mode having different resonance frequencies, similarly to the resonance element of FIGS. 8A and 8B, and the two resonators are coupled to the lines 21b and 21c, respectively and independently. As a result, the oscillator device, although it uses the single dielectric resonance element, functions as a two frequency oscillator device which outputs two oscillation signals with different frequencies. FIGS. 23A and 23B show the positional relationship between the resonance modes of the above-described dielectric resonance element and the two lines. In this example, the lines for the two sets of the oscillators are arranged on the substrate substantially in parallel to each other, and the dielectric resonance element 1 is arranged in such a manner that the center line of the dielectric member which functions as the dielectric resonance element 1 (the common center line of the two flat plate portions crossing each other) is in parallel to the substrate. FIG. 23A shows the even mode electromagnetic field distribution, and FIG. 23B shows the odd mode electromagnetic field distribution. The line 21c is selectively coupled to the even mode magnetic field, and the line 21b is selectively coupled to the odd mode magnetic field as described above.

Since the dielectric resonance element 1 is arranged in such a manner that the center line of the dielectric member which functions as the dielectric resonance element is in parallel to the substrate, as described above, the two lines 21b and 21c can be arranged on the substrate in parallel to each other. Thus, arrangement of the whole oscillator on the substrate can be easily performed, and the whole oscillator device can be more reduced in size.

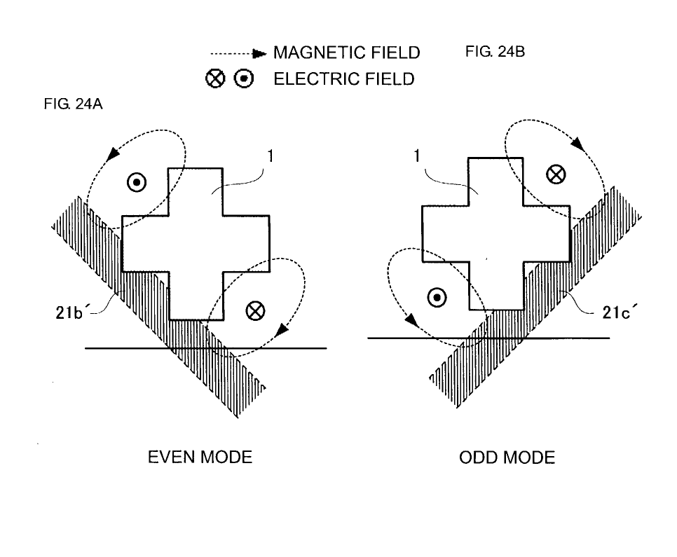

In an example shown in FIGS. 24A and 24B, the dielectric resonance element is arranged on a substrate through a supporting stand in such a manner that the supporting stand is joined to the plane perpendicular to the center line of the dielectric resonance element, that is, the dielectric resonance element is arranged in such a manner that the center line becomes perpendicular to the substrate. FIGS. 24A and 24B are plan views. In this case, the lines need to be arranged in parallel to the electric field planes, respectively. The line 21b′ is arranged in parallel to the electric field plane of the even mode as shown in FIG. 24A to be coupled to the even mode. The line 21c′ is arranged in parallel to the electric field plane of the odd mode as shown in FIG. 24A to be coupled to the odd mode. As a result, the two lines 21b′ and 21c′ are arranged orthogonally to each other. Thus, the circuit arrangement becomes complicated.

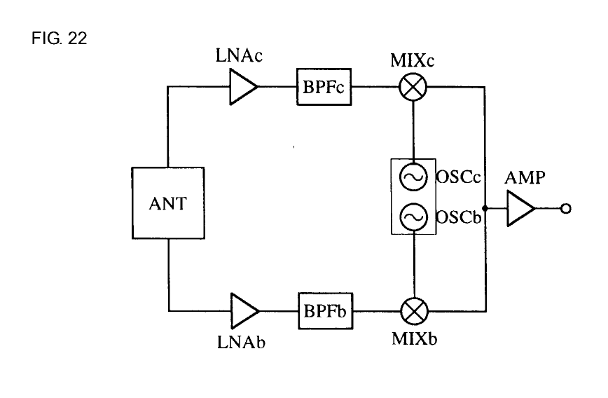

Hereinafter, a communication device according to a nineteenth embodiment of the present invention, especially the configuration of a converter unit will be described with reference to FIG. 22. This converter receives a radio wave which is transmitted from a broadcasting satellite (BS) and a communication satellite (CS), and converts the radio wave to an intermediate frequency signal. In FIG. 22, ANT designates the reception probe of an antennal useful for both BS and CS. Low noise amplifiers LNAa and LNAb amplify BS and CS signals received through the antenna ANT. Band-pass filters BPFb and BPFc transmit only signals in a required frequency band of the signals amplified by the amplifiers LNAb and LNAc.

Oscillators OSCb and OSCc, which are the same as those shown in FIG. 21, generates local signals for BS and CS, respectively. Preferably, two oscillators are provided in the form of a single oscillator device as shown in FIG. 20.

Mixers MIXb and MIXc mix the local signals with the reception signals to output the intermediate frequency signals, respectively. An amplifier AMP amplifies the intermediate frequency signals to output them to a reception circuit in the succeeding stage.

Although the present invention has been described in relation to particular embodiments thereof, modifications and other uses will become apparent to those skilled in the art. Accordingly, it is preferred that the present invention not be limited by the specific disclosure herein, but only by the appended claims.

What is claimed is:

1. A dielectric resonance element comprising:
a dielectric member having a first plate portion and a second plate portion, the first and second plate portions intersecting each other and having respective center lines which are coincident with each other,
wherein TE01δ mode electromagnetic fields are generated in the first and second plate portions, respectively, such that electric field vectors are turned in respective in-plane directions of the first and second plate portions.

2. The dielectric resonance element according to claim 1, wherein the first and second plate portions intersect at an intersecting angle which is less than 90°.

3. The dielectric resonance element according to claim 1, wherein a thicknesses of the first plate portion is different than a thickness of the second plate portion.

4. The dielectric resonance element according to claim 1, wherein a shape of the first plate portion is different than a shape of the second plate portion.

5. The dielectric resonance element according to claim 1, wherein a corner of the first and second plate portions is chamfered or rounded.

6. The dielectric resonance element according to claim 1, wherein a hole is at least partially formed in a side-face of at least one of the first and second plate portions.

7. The dielectric resonance element according to claim 1, wherein a hole or a perforation is formed in at least one of the intersecting portions of the first and second plate portions.

8. The dielectric resonance element according to claim 1, wherein a concavity is formed in an intersecting portion of the first and second plate portions.

9. The dielectric resonance element according to claim 1, wherein a protuberance is formed in an intersecting portion of the first and second flat plate portions.

10. The dielectric resonance element according to claim 1, wherein a supporting stand made of a material having a lower dielectric constant than the dielectric member is joined to a side face of one of the first and second plate portions so as to be perpendicular to the center lines of the first and second plate portions.

11. The dielectric resonance element according to claim 1, wherein a supporting stand made of a material having a lower dielectric constant than the dielectric member is joined to a side face of one of the first and second plate portions so as to be substantially in parallel to the center lines of the first and second plate portions.

12. A dielectric resonator comprising a dielectric resonance element defined in claim 10, and a cavity for accommodating the dielectric resonance element.

13. A filter comprising the dielectric resonator defined in claim 12 and an input-output coupling means which is coupled to a predetermined resonance mode of the dielectric resonance element of the dielectric resonator.

14. The filter according to claim 13, wherein plural dielectric resonance elements are arranged so that the first and second plate portions of the plural dielectric resonance elements are not in parallel to inner walls of the cavity.

15. The filter according to claim 13, wherein the plural dielectric resonance elements are arranged so that at least one of the first plate portions and the second plate portions of the plural dielectric resonance elements are positioned in the same direction and in the same plane with center lines thereof being directed in parallel to upper and lower surfaces of the cavity.

16. The filter according to claim 15, further including another dielectric resonance element arranged so that a center line thereof is perpendicular to the upper and lower surfaces of the cavity, and the dielectric resonance element is coupled to the plural dielectric resonance elements.

17. A filter including a single mode resonance element coupled to the dielectric resonance element defined in claim 14.

18. An oscillator device comprising:
two oscillators, each oscillator containing a line, a positive element connected to one end of the line, and a dielectric resonance element connected to an intermediate point of the line,
wherein each of the dielectric resonance elements are disposed on a substrate having the lines and the positive elements formed thereon, and electromagnetic fields of two coupling modes generated between two TE01δ modes of the dielectric resonance elements are coupled to the lines of the two oscillators, respectively, each of the dielectric resonance elements having a first plate portion and a second plate portion, the first and second plate portions intersecting each other and having respective center lines which are coincident with each other.

19. The oscillator device according to claim 18, wherein the lines of the two oscillators are arranged substantially in parallel to each other, the dielectric resonance elements further include a supporting stand made of a material having a lower dielectric constant than the dielectric member and joined to a side face of one of the first and second plate portions so as to be substantially in parallel to the center lines of the first and second plate portions, and the magnetic fields in an odd mode and an even mode are coupled to the lines of the two oscillators, respectively.

20. A dielectric resonance element comprising:
a dielectric member having integrally formed first and second substantially square plate portions which intersect each other,
wherein TE01δ mode electromagnetic fields are generated in the first and second flat plate portions, respectively, such that electric field vectors are turned in respective in-plane directions of the first and second plate portions, respectively.
